(19) United States
(12) Patent Application Publication
(10) Pub. No.: US 2010/0000108 A1
(43) Pub. Date: Jan. 7, 2010

(54) CORE BARREL CAPACITY GAUGE

(75) Inventor: Damien Jonathon Stockton, Perth (AU)

Correspondence Address: MAIER & MAIER, PLLC, 1000 DUKE STREET, ALEXANDRIA, VA, 22314, US

(73) Assignee: CORETRACK, LTD., Perth (AU)

(21) Appl. No.: 12/440,965

(22) PCT Filed: Sep. 19, 2007
(86) PCT No.: PCT/AU2007/001376

§ 371 Date: Mar. 12, 2009

(30) Foreign Application Priority Data
Sep. 21, 2006 (AU) 2006905214

(51) Int. Cl. G01B 3/00; E21B 49/00

(52) U.S. Cl. 33/501.02; 73/152.46; 33/1 H

(57) ABSTRACT

A core barrel capacity gauge (30) for use on a core barrel assembly (10) having a barrel (16) for receiving a core sample. The core barrel capacity gauge comprises a core sample marker (32) located within the barrel (16) such that the core sample marker (32) rests against the top of the drilled core sample. A wheel (42) is provided on the core sample marker (32) that engages with the inside of the barrel (16) such that movement of the core sample marker (32) along the length of the barrel (16) rotates the wheel. A rotation sensor (44) is provided in the core sample marker (32) that senses rotation of the wheel (42) and a transmitter (48) is provided in the core sample marker (32) in communication with the rotation sensor (44). The transmitter (48) transmits information regarding the rotation of the wheel (42) is received from the rotation sensor (44).

### FIELD OF THE INVENTION

The present invention relates to core barrel capacity gauge.

### BACKGROUND OF THE INVENTION

When it is required to obtain a cross sectional sample of a particular geological formation, it is known to use a core barrel assembly in place of a standard drill bit.

The core barrel assembly utilises a specialised core bit attached to a number of outer barrels that are interconnected to make up the desired length. The core bit drills downwardly and has a central opening such that the core bit cuts around a column of the formation that is to be the sample. An inner barrel is provided within the outer barrel for receiving the core sample. The inner barrel is provided with an adaptor at the lower end that allows the core to pass into the inner barrel but not to fall back out.

The process of obtaining a core sample generally commences by connecting the core barrel assembly to the standard drill pipe string and lowering it to the bottom of the hole. Fluid is pumped through the drill string into the core barrel assembly where it passes through the inner barrel and the cavity between the inner and outer barrels to flush them of debris. A diverter ball is dropped through the drill string before commencement of sampling to seal the opening to the inner barrel so that fluid pumped down the drill string is passed only through the cavity between inner and outer barrels and coring commences.

During coring, the core bit is designed to drill around a vertical column of the sample such that the inner barrel passes downwardly around the sample. A known problem that can occur in such a situation is that if the core column is not sufficiently stable, it can collapse downwardly within the inner barrel. The collapsed core column can create additional friction on the inner surface of the inner barrel resulting in jamming of the core.

Observations of the drilling fluid pressure, the torque and the rate of penetration can provide some indication of whether this core collapse has occurred, however it is not possible to rule out the possibility that changes in these values are the result of some other event (such as a change in the formation). The driller is therefore forced to make a decision that could result in continuing drilling when the core is jammed or stopping drilling when the core is not jammed, both situations resulting in an expensive loss of time and effort.

The present invention attempts to provide a device aimed at overcoming at least in part the aforementioned problem of detecting collapse of a core sample within a core barrel assembly.

### SUMMARY OF THE INVENTION

In accordance with one aspect of the present invention there is provided a core barrel capacity gauge for use on a core barrel assembly having a barrel for receiving a core sample, the core barrel capacity gauge comprising:

a core sample marker located within the barrel such that the core sample marker rests against the top of the drilled core sample;

a wheel on the core sample marker that engages with the inside of the barrel such that movement of the core sample marker along the length of the barrel rotates the wheel;

a rotation sensor in the core sample marker that senses rotation of the wheel; and

a transmitter in the core sample marker in communication with the rotation sensor;

wherein the transmitter transmits information regarding the rotation of the wheel is received from the rotation sensor.

Preferably, a marker location sensor is provided to receive the signal transmitted from the core sample marker.

Preferably, the rotation sensor senses the direction and angular distance of rotation of the wheel in the core sample marker. In a preferred embodiment, the wheel includes one ore more magnets mounted around the periphery of the wheel and the rotation sensor is mounted adjacent the periphery of the wheel includes means to sense the magnetic field created by the magnets as the magnets pass the rotation sensor. The transmitter may transmit a signal each time one of the magnets passes the rotation sensor.

Preferably the signal transmitted by the transmitter comprises a percussion wave transmitted in the drilling fluid.

In one embodiment the marker location sensor is arranged in the core barrel assembly and the marker location sensor detects the signal received from the transmitter in the core sample marker and transmits a signal to the surface. The marker location sensor may transmit the signal to the surface by a percussion wave in the drilling fluid.

The core sample marker may include a pressure sensor and the transmitter in the core sample marker transmits information regarding the pressure sensed by the pressure sensor. The core sample marker may also include a temperature sensor and the transmitter in the core sample marker transmits information regarding the temperature sensed by the temperature sensor.

### BRIEF DESCRIPTION OF THE DRAWINGS

The present invention will now be described, by way of example, with reference to the accompanying drawings, in which:

FIG. 1 is a side cross sectional view of a core barrel assembly of known configuration;

FIG. 2 is a side cross sectional view of the core barrel assembly of FIG. 1 during the process of obtaining a core sample;

FIG. 3 is a side cross sectional view of the core barrel assembly of FIG. 1 during the process of obtaining a core sample where the core sample has collapsed;

FIG. 4 is a side cross sectional view of a core barrel assembly having a core barrel capacity gauge on top of the drilled core sample; and

FIG. 5 is a side cross section view of a core sample marker in accordance with the present invention.

### DESCRIPTION OF THE INVENTION

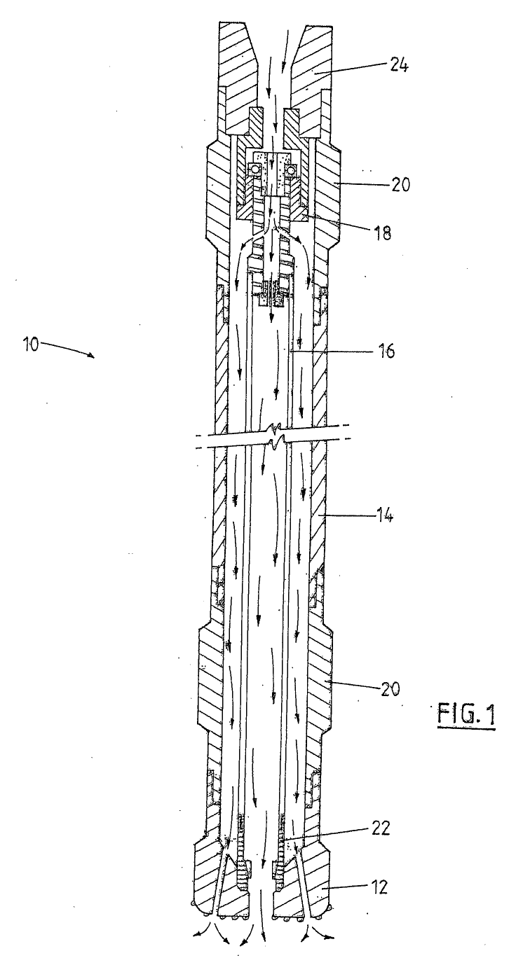

Referring to the FIGS. 1 to 3, there is shown a core assembly 10 on which the core barrel capacity gauge of the present invention may be used. The core barrel assembly 10 includes a core bit 12 attached to the lower end of one or more outer barrels 14. The outer barrels 14 are connected to a top adaptor 24 that includes a swivel assembly 18 onto which is attached an inner barrel 16 for receiving the core sample. Stabilisers 20 are provided between the adjacent outer barrels 14.

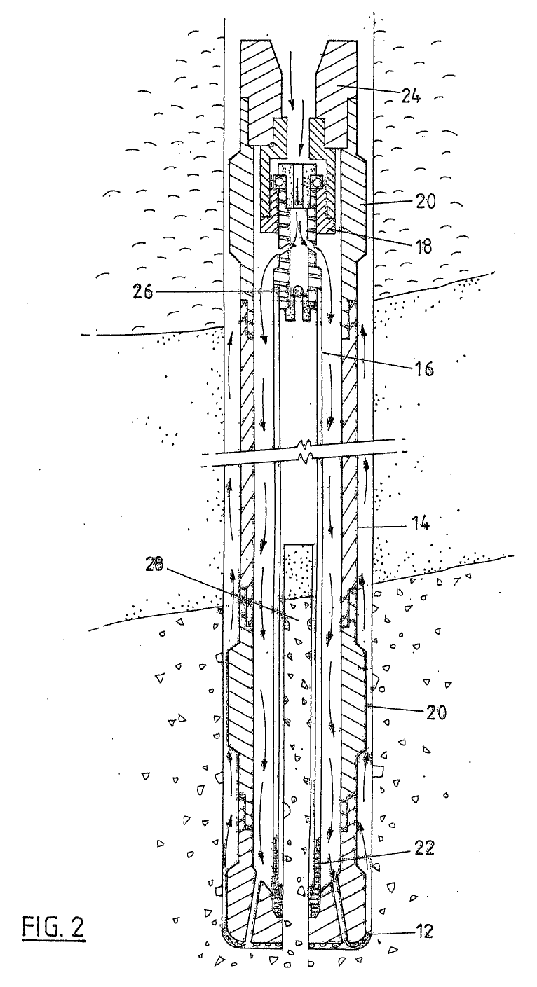

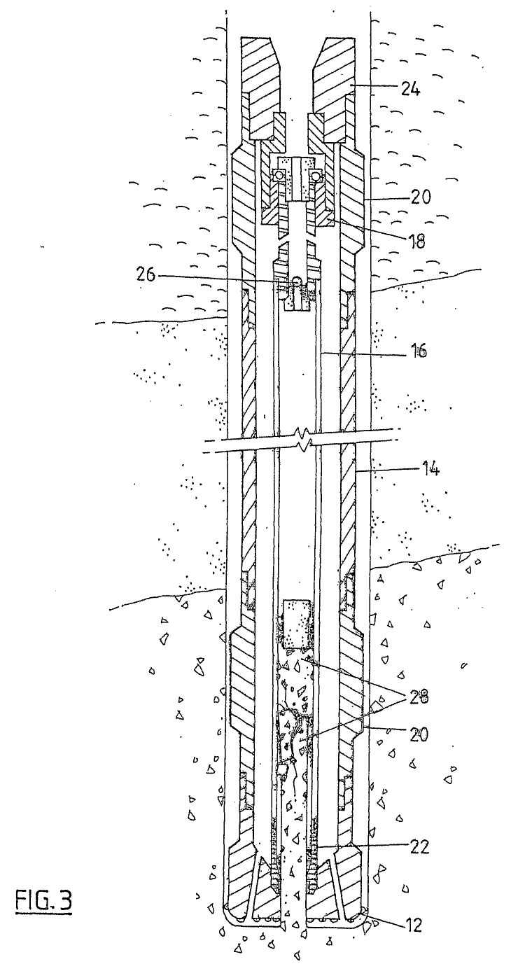

FIG. 1 shows the core barrel assembly 10 before the commencement of the coring process. Drilling fluid is passed downwardly through the top adaptor 24 and passes via the swivel assembly 18 into the inner barrel 16 and the cavity between the inner barrel 16 and the outer barrel 14. Before the commencement of the coring process, a diverter ball 26 is dropped down into the swivel assembly to prevent drilling fluid passing into the inner barrel 16. The core sample 28 is then received within the inner barrel 16 as shown in FIG. 2 during a normal core sampling operation. FIG. 3 shows an example of the coring process in which the core sample 28 has collapsed. As can be see, the collapsed core sample 28 fills the clearance left between the core sample 28 and the inner barrel 16 thereby creating friction.

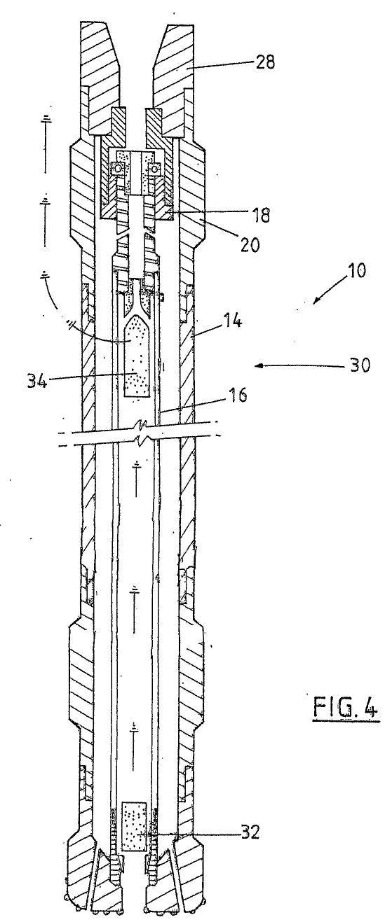

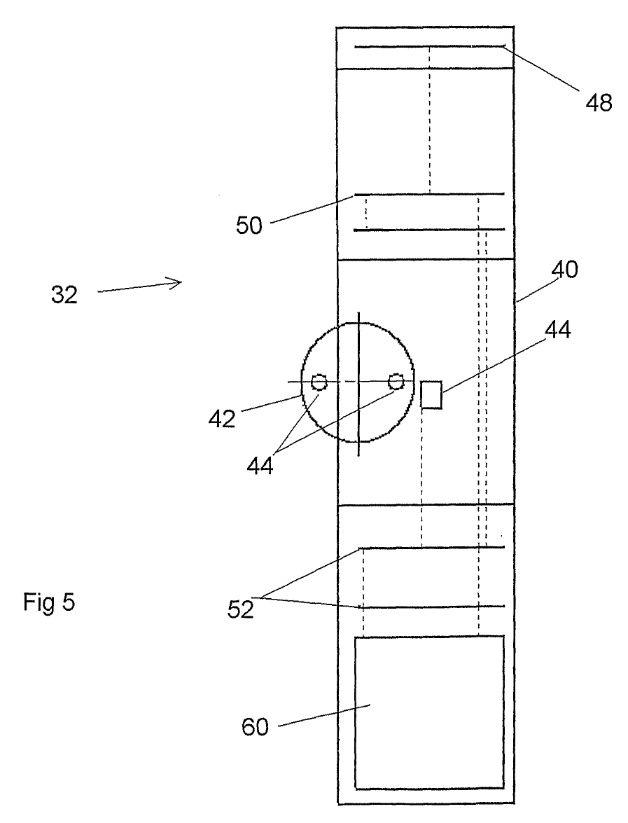

Referring to FIGS. 4 and 5 there is shown a core sample capacity gauge 30 provided on a core barrel assembly 10 of the type shown in FIGS. 1 to 3. The core barrel capacity gauge 30 includes a core sample marker 32 and a marker location sensor 34. The marker location sensor 34 is arranged to detect the location of the core sample marker 32 within the inner barrel 16.

In the embodiment shown, the core sample marker 32 comprises a housing 40 having a means to sense movement of the core sample marker 32 along the barrel 16. The means to sense movement includes a wheel 42 rotatably mounted to the housing 40 such that the wheel engages with the inner surface of the inner barrel 16. The means to sense movement also includes a rotation sensor 44. The rotation sensor 44 is located within the housing 40 adjacent the wheel 42 such that the rotation sensor 44 can sense the direction and angular distance of rotation of the wheel 42.

In the embodiment shown, the wheel 42 includes one or more magnets 46 mounted around the periphery of the wheel 42 and the rotation sensor 44 includes means to sense the magnetic field generated by the magnets 46 as the magnets 46 pass the rotation sensor 44.

The core sample marker 32 also includes a transmitter 48 and associated transmitter circuitry 50. The transmitter circuitry 50 is in communication with rotation sensor circuitry 52 in communication with the rotation sensor 44. Information regarding the rotation of the wheel 42 is thereby passed to the transmitter 48 which can transmit information to the marker location sensor 34. A power source 60 is provided to supply power to the circuiting and transmitter 48. The transmitter 48 produces a signal in the form of a percussion wave which is transmitted up the inner barrel 16 in the drilling fluid. The information transmitted by the transmitter 48 may simply consist of a percussion wave transmitted each time one of the magnets 46 passes the rotation sensor 44. By appropriate spacing of the magnets 46 around the wheel 42, the timing between transmitted waves can be used to determine rotation of the wheel 42, which can be translated into vertical position of the core sample marker 32 in the barrel 16.

The marker location sensor 34 is provided within the inner barrel 16 adjacent the swivel assembly 18. The marker location sensor 34 detects the percussion wave generated by the core sample marker 32 and transmits, by a suitable means, a signal to a signal receiver (not shown) at the surface. The signal transmitted to the surface by the marker location sensor 34 may also be in the form of a percussion wave signal transmitted through the drilling fluid. The signal receiver at the surface includes a suitable means to indicate to the driller the location of the core sample marker 32 within the inner barrel 16 based on the signals received from the marker location sensor.

As the driller is then able to determine the position of the core sample marker 32 (and therefore the top of the core sample) with respect to the inner barrel 16, it is possible to determine any collapse of the core sample 28. That is, if the distance the distance the inner barrel 16 has passed the core sample marker 32 is significantly less than the distance drilled down, then the driller will know that some collapse of the core sample 28 has occurred.

The core barrel capacity gauge 30 may also be provided with a pressure sensor (not shown) and a temperature sensor (not shown) to provide information to the operator regarding the pressure of the drilling fluid and temperature within the core barrel assembly. Also, a rotational sensor (not shown) may be provided to indicate to the operator whether the inner barrel 16 is rotating with outer barrel 14. Further, a vibration sensor may be provided within the core sample marker 32 such that measurements of vibration sensed by the core sample marker 32 may be transmitted to the operator. The temperature, pressure, vibration and rotational information may be used by the operator to further assess the progress of the coring operation.

Modifications and variations as would be apparent to a skilled addressee are deemed to be within the scope of the present invention.

1. A core barrel capacity gauge for use on a core barrel assembly having a barrel for receiving a core sample, the core barrel capacity gauge comprising:
a core sample marker located within the barrel such that the core sample marker rests against the top of the drilled core sample;
a wheel on the core sample marker that engages with the inside of the barrel such that movement of the core sample marker along the length of the barrel rotates the wheel;
a rotation sensor in the core sample marker that senses rotation of the wheel; and
a transmitter in the core sample marker in communication with the rotation sensor;
wherein the transmitter transmits information regarding the rotation of the wheel is received from the rotation sensor.

2. A core barrel capacity gauge in accordance with claim 1, wherein a marker location sensor is provided to receive the signal transmitted from the core sample marker.

3. A core barrel capacity gauge in accordance with claim 1, wherein the rotation sensor senses the direction and angular distance of rotation of the wheel in the core sample marker.

4. A core barrel capacity gauge in accordance with claim 1, wherein the wheel includes one ore more magnets mounted around the periphery of the wheel and the rotation sensor is mounted adjacent the periphery of the wheel includes means to sense the magnetic field created by the magnets as the magnets pass the rotation sensor.

5. A core barrel capacity gauge in accordance with claim 4, wherein the transmitter transmits a signal each time one of the magnets passes the rotation sensor.

6. A core barrel capacity gauge in accordance with claim 1, wherein the signal transmitted by the transmitter comprises a percussion wave transmitted in the drilling fluid.

7. A core barrel capacity gauge in accordance with claim 2, wherein the marker location sensor is arranged in the core barrel assembly and the marker location sensor detects the signal received from the transmitter in the core sample marker and transmits a signal to the surface.

8. A core barrel capacity gauge in accordance with claim 7, wherein the marker location sensor transmits the signal to the surface by a percussion wave in the drilling fluid.

9. A core barrel capacity gauge in accordance with claim 1, wherein the core sample marker includes a pressure sensor and the transmitter in the core sample marker transmits information regarding the pressure sensed by the pressure sensor.

10. A core barrel capacity gauge in accordance with claim 1, wherein the core sample marker includes a temperature sensor and the transmitter in the core sample marker transmits information regarding the temperature sensed by the temperature sensor.

11. A core barrel capacity gauge in accordance with claim 1, wherein the core sample marker is provided with a vibration sensor. And the transmitter in the core sample marker transmits information regarding the vibration sensed by the vibration sensor.
